(19) United States
(12) Patent Application Publication
(10) Pub. No.: US 2005/0095105 A1
(43) Pub. Date: May 5, 2005

(54) Conical warning marker placer

(76) Inventor: William Parks, Joliet, IL (US)

Correspondence Address: National IP Rights Center, LLC, Suite 400, 550 Township Line Road, Blue Bell, PA, 19422, US

(21) Appl. No.: 10/693,622

(22) Filed: Oct. 23, 2003

(51) Int. Cl. B60P 1/00

(52) U.S. Cl. 414/540

(57) ABSTRACT

An apparatus for releasing a single road cone at a timed interval comprising a mechanism comprising at least one reciprocating shoe which support a plurality of road cones in a first position, and which lock a single cone on a second position which is then released at a timed interval, a chute proximate to the door to permit said released cone to slide downward toward the road surface, and a vertical angle slide plate affixed to said chute to permit said cone to be released smoothly onto a road surface as the vehicle moves forward.

### FIELD OF THE INVENTION

The invention is directed to a novel apparatus that places conical roadway warning markers at spaced apart distances as a vehicle moves forward without the need for any human intervention.

### BACKGROUND OF THE INVENTION

Much highway construction, maintenance and repair activities require a physical separation between a designated work area and lanes that remain open to traffic. The federal government and many U.S. states have now mandated that road cones be separated at specified intervals. Busy highways, fast moving traffic and debris traveling at high speeds create an extremely hazardous environment that presents a great danger to work crews.

High visibility cone-shaped safety markers are commonly used to close a number of lanes and create a safety zone where crew workers can perform maintenance, repair, and construction on the highway. Although a variety of safety markers exist, traffic cones are the most common because they can be stored compactly, are easily transported, and require no assembly. In addition, traffic cones are widely available in different sizes and weights to satisfy various traffic and road conditions.

Manual deployment of traffic cones is a method used worldwide, although several automated cone placement and retrieval devices have been developed to assist with this tedious and dangerous procedure. One such device is capable of retrieving and storing approximately between 1500 and 2000 traffic cones, and can be operated by a single driver at up to speeds above 35 mph. This device picks up standing cones by first capturing them with two revolving paddle wheels. The traffic cones are then moved upward and rearward by a conveyor.

The cone is then placed in a depositing area where cones are stacked vertically. Once the cones are stacked to a predetermined height, the cone stack is released on sloped rollers and placed on the rear end of the vehicle. The cone stacks could also be moved laterally on rollers to maximize the vehicle's storage capacity. The problem that is apparent with this device is its impracticality due to the bulky nature of the retrieving mechanisms and the large frame of the vehicle. In addition, cones that are knocked over present a difficult problem for this machine since it has no means of manipulating the cones on the road surface.

Another known device provides for the automated retrieval of traffic cones, has an operating speed of approximately 11 mph and a storage capacity of 240 traffic cones. During retrieval procedures, the driver must manipulate the cone into one of two positions using short vertical bars that can orient the cones in either a base first or a cone tip first configuration. If manipulated into a base first configuration, the cone can be picked up as if it were an upright cone.

However, if the cone is placed in a cone tip first position, a horizontal bar is lowered to contact the base of the cone and flip it so that the cone falls into the base first configuration. With the vehicle moving forward, a prong enters through the open bottom of the cone and lifts the cone upwards. Once a cone has been picked up, a chain link conveyor is used to lift the cone upwards to a chute that leads to the storage area. The cone is stripped from the prong by a simple bar mechanism and it falls through the chute. The falling cone is stacked vertically in one of ten vertical cylinders that form a circular ring.

The patent literature has identified a number of systems which are directed to the placement and retrieval of road cones. U.S. Pat. No. 6,056,498 is directed to an apparatus which automatically retrieves conical highway warning markers from the roadway and transports the cones to a support vehicle for storage. The apparatus, which is attached to a vehicle, comprises a claming plate disposed at the end of a lifting arm, which clamps the base of the traffic cone onto a platform. The lifting arm then rotates to raise the cone to a position for stowage. The raised cone can then be manually removed from the lifting arm for stowage or, alternatively, dropped onto a conveyor system which transports the traffic cone to a storage area within the vehicle.

U.S. Pat. No. 6,158,948 to Calvert is directed to a system for collecting traffic cones and is provided including a tractor and a trailer connected to the tractor for trailing the same. Next provided is a pick-up assembly for picking up a cone and placing the same on the trailer for stacking. Also, a conveyor is mounted on the trailer for transporting the cones to a rear extent of the trailer.

U.S. Pat. No. 4,262,831 to Buchanan is directed to a traffic cone rack adapted to be mounted on a bumper, a floor or side panel of a vehicle. The device includes an elongated body portion adapted for securing to a portion of a vehicle. A cone support bail projects outward from the body for receiving traffic cones. A cone locking bail is tiltably secured to the body and moves over a fulcrum point for locking the traffic cones on the bail in a carrying position. An adjunct to the device is a warning buzzer which sounds when the locking bail is in the open position and the ignition switch of the vehicle is on.

U.S. Pat. No. 4,219,141 is directed to a supporting frame for use on motor vehicles for supporting highway traffic markers of the type having a flat square base and an elongated brightly colored cone extending vertically therefrom (commonly called traffic cones). The supporting frame is characterized by its ability to be installed on the vehicle in almost any position, e.g., horizontally or vertically. The frame comprises rectangular box-shaped framework having an interior shape fitting the periphery of the square bases of the traffic cones. The frame is open at one end for insertion and removal of traffic cones and has two open sides facilitating removal of said traffic cones. The supporting frame has a ring spaced from the base portion thereof and supported on supporting rods. The ring supports the cone portions of the traffic cones and also provides a point of attachment for the supporting frame to the structural member of the vehicle.

There has been a long felt need for devices which can easily place safety cones on a road pursuant to federal and state governmental requirements and which can set such cones at specified intervals and with no human intervention based upon the speed of a vehicle. Such a system and device could be easily implemented by law enforcement, road and transportation crews and the like.

It is a principal object of the present invention to provide a system which permits the rapid deployment of road cones.

It is a further object of the present invention to provide a mechanism that can facilitate the placement of a plurality of road cones in the precise position and at the precise intervals as mandated by federal and state regulations.

It is a further object of the invention which facilitates the easy and quick placement of road cones by a work crew, without the need for human intervention.

It is a further object of the present invention to provide a system which can be attached to the back of a vehicle and which can be raised and lowered as required.

It is a further object of the present invention to provide a cone placement system which includes a chute to precisely drop and place the cones and which includes a drop plate.

It is a further object of the present invention to provide a system which can easily be placed on a wide variety of vehicles including cars and trucks.

These and other objects of the present invention will become apparent from the summary of the invention and detailed description which follows.

### SUMMARY OF THE INVENTION

The present invention is directed to a mechanism for opening permitting the release of a single cone onto a road bed, a reciprocating dual shoe mechanism under the arrangement for supporting a plurality of cones and for permitting a single cone to be released to the street level, and a slide plate for facilitating the release of the cone onto the street level.

In a more preferred embodiment, the invention is an apparatus for releasing a single road cone at a timed interval comprising a mechanism comprising at least one reciprocating shoe which supports a plurality of road cones in a first position, and which locks a single cone in a second position which is then released at a timed interval, a chute proximate to the shoe to permit said released cone to slide downward toward the road surface, and an angled slide plate affixed to said chute to permit said cone to be released smoothly onto a road surface as the vehicle moves forward.

In still a further embodiment, an apparatus for releasing a single road cone at a timed interval comprising, a mechanism comprising a pair of vertically separated reciprocating shoes supporting a plurality of road cones in a first position and which drop the stack of cones onto a second pair of shoes, said first pair closing to support the stack of cones above the lowermost cone; said second shoe pair then opening to release the single road cone, a chute proximate to the mechanism for permitting said single cone to slide downward toward the road surface, and a slide plate to permit said cone to be released smoothly onto a road surface as the vehicle moves forward.

### A BRIEF DESCRIPTION OF THE FIGURES

FIG. 1 is a side view of the mechanism of the present invention.

FIG. 2 is a side representation of the feeding mechanism of the present invention.

FIG. 3 is an overhead view of the dual shoe mechanism of the present invention with cam.

FIG. 4 is a side view of the dual shoe configuration of the present invention.

FIG. 5 is a side perspective view of the chain and sprocket mechanism for the lower shoe of the present invention.

FIG. 6 is an expanded view of the cam shoe system of the present invention.

FIGS. 7 and 8 are top views of the dual cams of the present invention.

FIG. 9 is a top view of the lower shoe pair.

FIG. 10 is an alternate embodiment of the invention, including a micro-processor based controller.

FIG. 11 is a perspective view of the gear box of the present invention.

FIGS. 12 and 12a illustrate the operation of the drop chute and slide bar.

### DETAILED DESCRIPTION OF THE PRESENT INVENTION

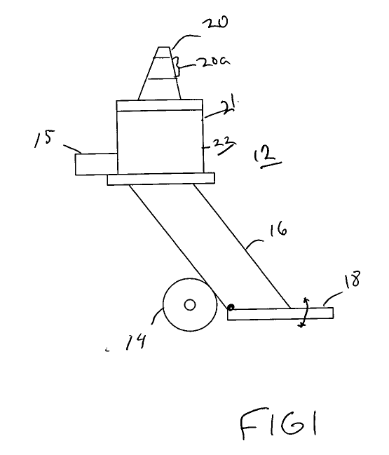

The present invention is described with reference to the enclosed Figures wherein the same numbers are utilized where applicable. The present invention provides a system for taking a stack of road cones and rapidly placing them on a roadway, one at a time. Referring to FIG. 1, a preferred embodiment of the present invention is shown in detail. As shown, the invention, in a preferred embodiment, comprises a mechanism 12 supported by road wheels 14 and which is configured to attach to the body of a truck, car or trailer with a hitch. The system may be configured to lift off of the road surface.

An angled chute 16 permits the single cone to descend to the road bed to a drop plate 18. The mechanism supports a plurality of stacked cones 20 in a hopper 21 and functions to feed the cones individually to the road bed as the vehicle supporting the device moves forward.

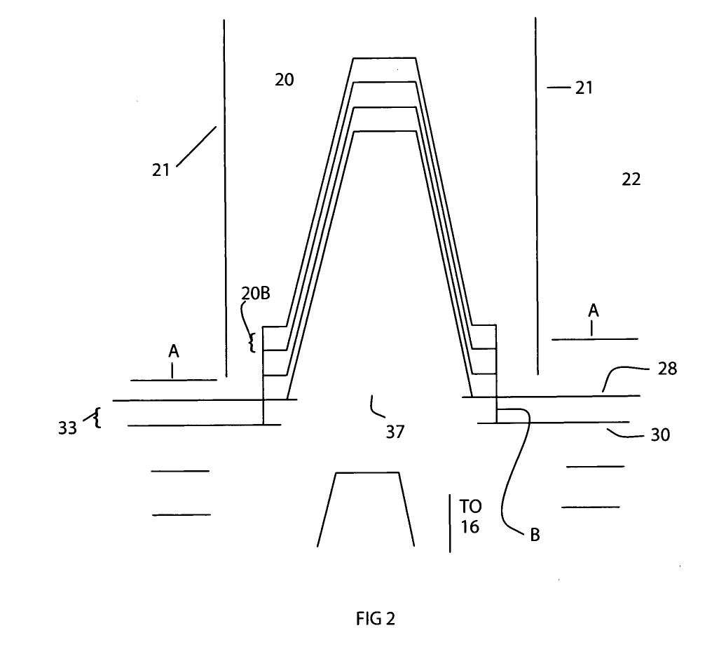

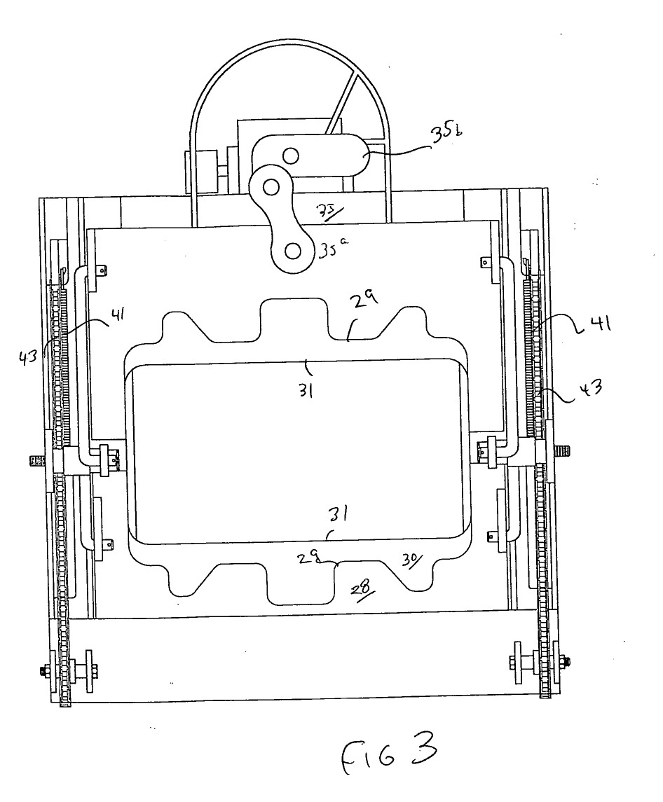

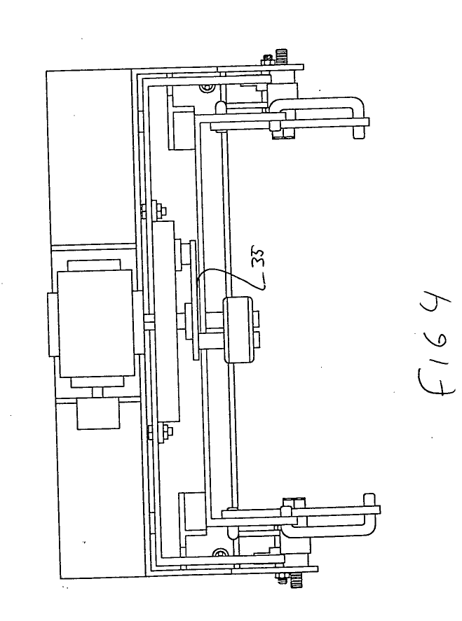

Referring to FIGS. 2 and 3, the main component of the present invention comprises a multi-component system 22 which permits the plurality of road cones 20 to be individually placed on the road, one at a time, and at pre-defined spaced apart intervals, depending upon the speed of the vehicle used to drop the cones. The system includes hopper 21 which supports a plurality of cones 20. It is to be appreciated that the hopper 21 can have a plurality of diameters (Arrow A) to accommodate cones having a number of diameters and sizes and may include adjustable sidewalls.

The cones 20 in the preferred embodiment comprise standard polymeric road cones having the typical conical shape and including appropriate horizontal striping 20a (see FIG. 1). The cones have the typical annular ledge 20b about their lower periphery which form a ring to provide stability and support for the cones. The cones 20 are stacked in batches and inserted into the hopper 21. It is to be appreciated that a number of mechanisms are envisioned by the invention for placing the cones in the hopper including by manual feed or by a mechanical feed mechanism.

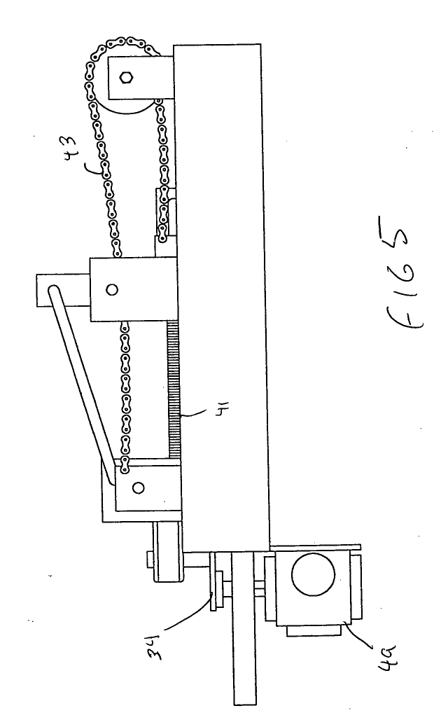

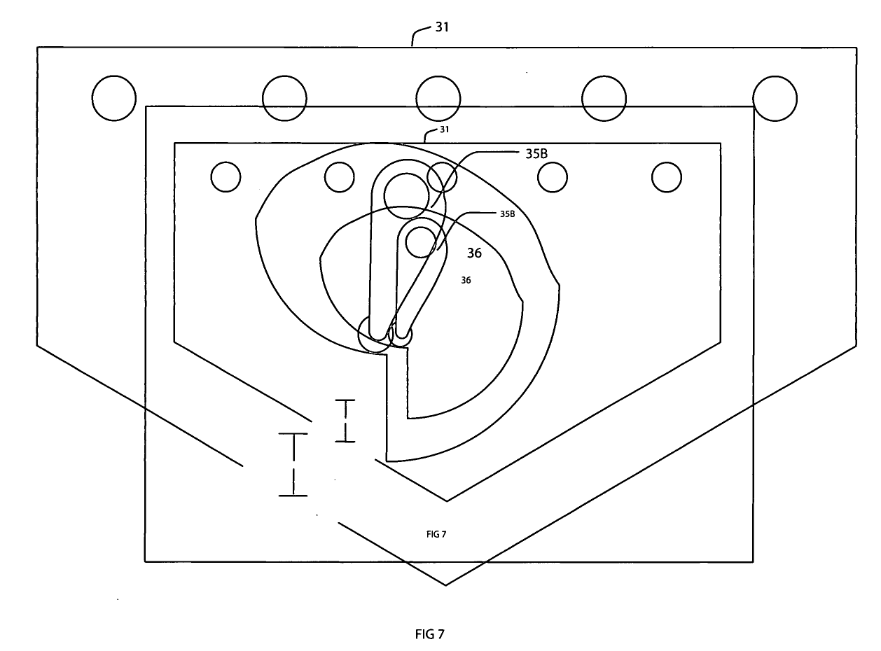

The critical internal component of the present invention is the cone feeding system 22 shown in FIGS. 2, 3, 4, and 6. This includes two reciprocating substantially horizontal shoe pairs 28, 30 which operate to permit a single cone to be fed through chute 16 and down to the roadbed via plate 18.

As shown in FIGS. 2 and 3, the top substantially horizontal shoe pairs have a serrated or undulated profile 29 over which the plurality of cones are supported. The lower pair of shoes has a square profile 31 and is separated vertically from the top shoes by a width 33 equal to the height of the lower annular rim 20b of a single cone 20. Hence, the shoes are vertically separated such that the lower shoes 28 can support the single lowermost cone while the top shoes 30 support the rest of the stack.

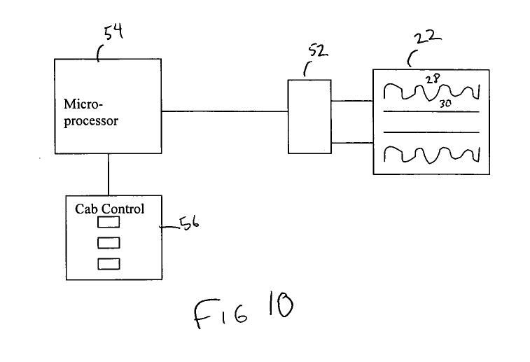

FIGS. 2 to 9 show the operation of the reciprocal sets of shoes pairs 28, 30. In one embodiment, the shoes operate by means of a dual action cam mechanism 35 which effectively operates to slide the upper set of shoes 28 in a first direction while simultaneously moving the lower set of shoes 30 in an opposite direction. It is to be appreciated that other mechanisms fulfill the spirit and scope of the invention. For example, the present invention can be used in conjunction with an electromechanical controller computer or optical controller to operate the reciprocating shoes, is most particularly shown in FIG. 10.

In the preferred embodiment, the invention incorporates a chain and sprocket system for moving the system which is pre-set to the movement of the vehicle. In this way, cones can be placed at exact intervals, based upon the joint operation of the cams.

As noted, the first shoe set comprises a pair of substantially flat and horizontal shoe plates 28 which have a secrated profile 29 which defines an area which supports the stack of cones 20 and provides an opening 37 through which a single cone can drop. The second shoe plate comprises a square edge plate 31 pair which supports the entire stack.

The shoe plates move inwardly and outwardly in a reciprocating configuration such that when the top pair of shoe plates 28 move outward, the second pair of shoe plates 30 below move inward. When the top plates 28 move outward pursuant to cam action 35, the entire set of cones 20 drops through to the lower shoe plates 30. The top shoe plates then move forward and secure the cones above the bottom-most cone. The bottom cone is then supported and positioned between the top and bottom shoes 28, 30 (See Point B of FIG. 2). When the bottom shoes 30 move outward, the lowermost cone is released.

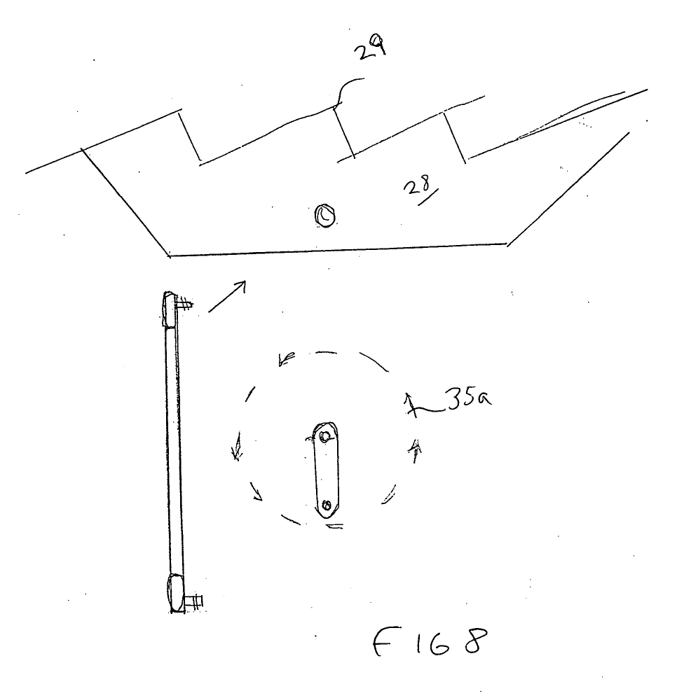

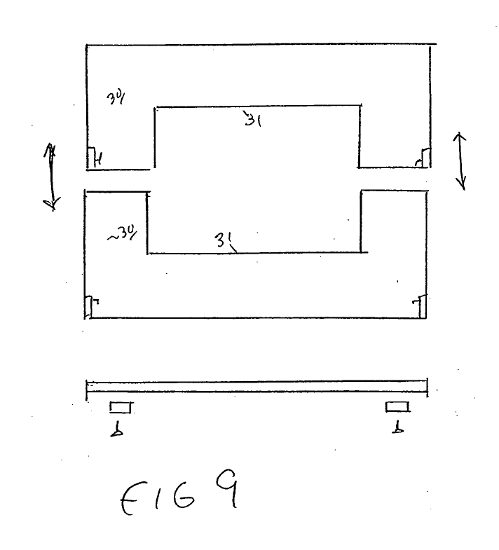

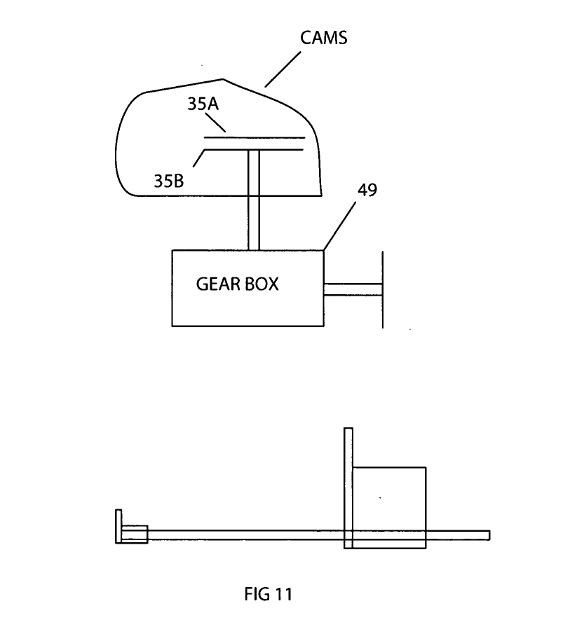

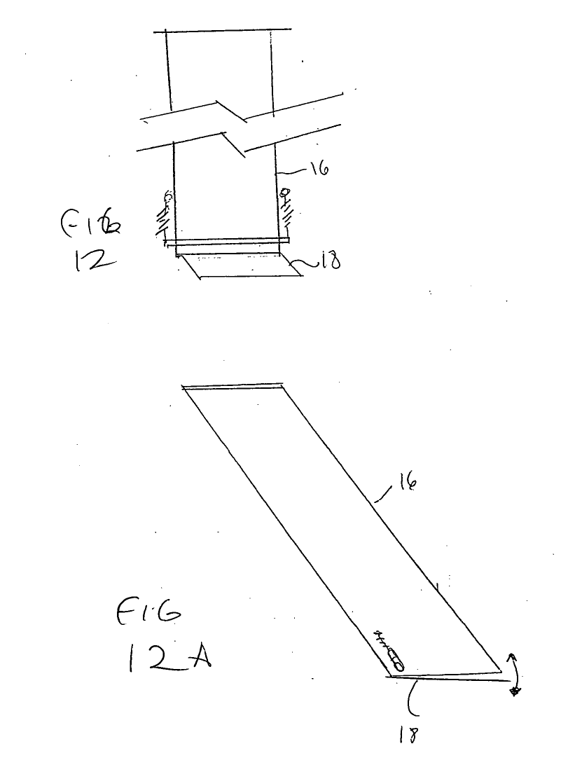

The operation of the cams is shown in FIGS. 7 and 8. As shown, the top cam 35a associates with the top shoe 20, is uniform in circumference and the lower cam 35b associates with flat shoe 30 and has dead zone 36. This is also affixed to gear box 49 shown in FIG. 11. When the lower plate 30 moves outward, it reaches a point where the cone drops all the way through the system, out to chute 16, onto a position plate 18 and then onto the roadway.

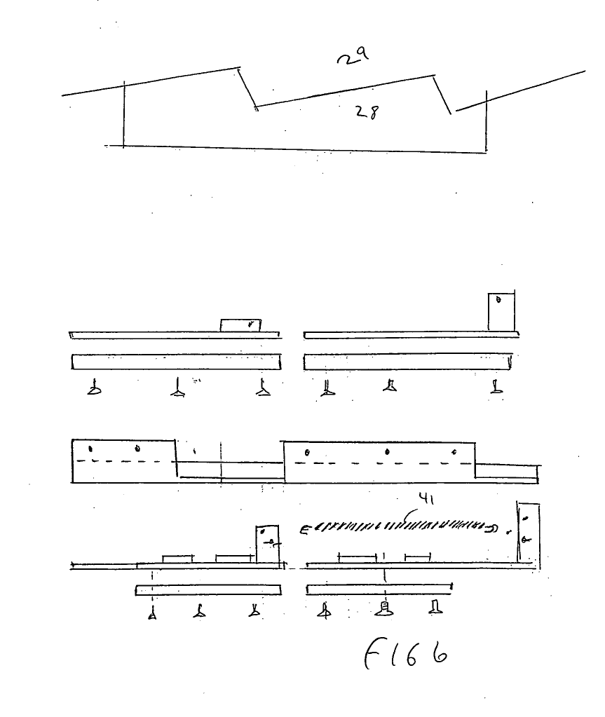

As shown in FIGS. 3 and 5, the outward movement of the lower shoes 30 is accomplished by a dual chain and sprocket 43 moved by a cam 34 and is biased by variable springs 41. After the cam 35 reaches a dead zone 36, the biasing springs 41 forces the lower shoes 30 backward in a snap action. This is a critical feature of the present invention which functions to prevent the creation of a dead space or zone between respective open positions of the top and bottom shoes 28, 30 which would permit multiple cones to slip through the system and onto the road. Hence, as the cam 35 rotates, it reaches a dead point wherein the snap-spring 41 closes the lower shoes 30.

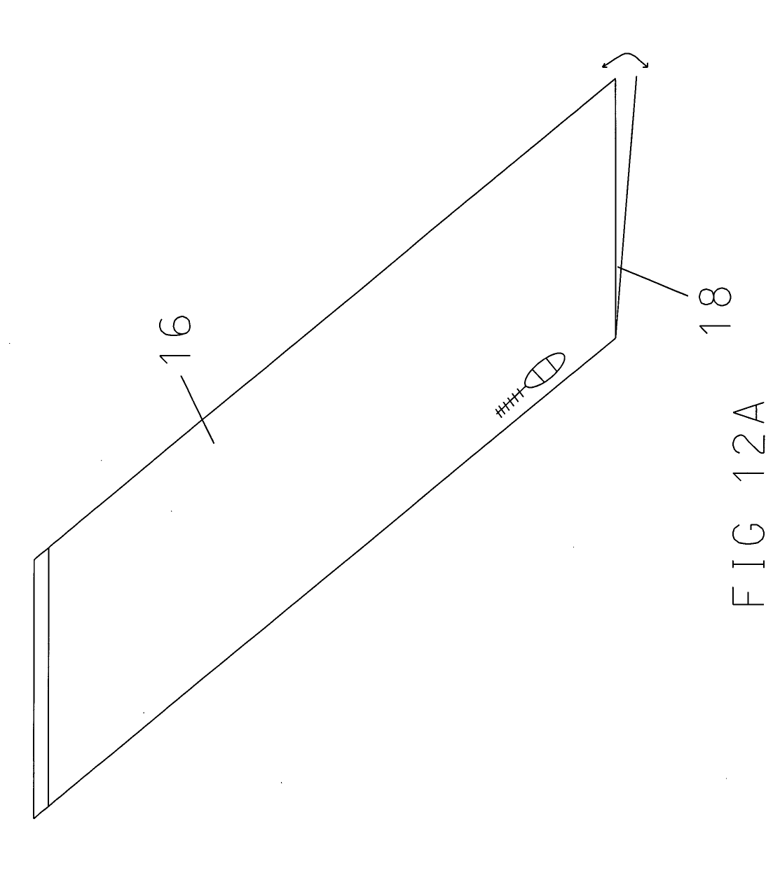

The angled chute tip bar 18 is shown in greater detail in FIGS. 12 and 12a. As can be seen, once a single cone 20 drops out of the lower shoe 30, it slides at a variable angle down to the slide plate 18. The slide plate 18 which is spring activated 50 then functions to permit a cone to land easily and gently on the road by means for friction.

It is to be appreciated that the present invention has been described in the context of a dual cam mechanism. It is to be noted that the present invention may be configured in any number of alternative embodiments, including the use of micro-electronics, optical sensors and other devices which are timed vis-à-vis the speed and location of the vehicle. FIG. 10 illustrates such an alternative embodiment of the present invention which utilizes a microcomputer 54 in association with an activation mechanism such as pneumatic, hydraulic or solenoid actuators 52. The actuator controls the upper and lower shoe pairs (28, 30) in the manner of the cam 35. The driver uses an input pad or control 56 in the vehicle's cab to program the actuator based on the speed of the vehicle and the desired separation. The actuator may also raise and lower the system.

The present invention has been described with reference to the enclosed Figures and detailed description. It is to be appreciated that other embodiments fulfill the spirit and scope of the invention and that the true nature of the invention is to be determined with reference to the Claims.

1. A mechanism for opening permitting the release of a single cone onto a road bed;
a reciprocating dual shoe mechanism under the arrangement for supporting a plurality of cones and for permitting a single cone to be released to the street level; and
a slide plate for facilitating the release of the cone onto the street level.

2. The apparatus at claim 1 wherein said cam is timed at the speed of the vehicle to drop a single road cone at a pre-timed interval.

3. The apparatus of claim 1 wherein said cam is powered by a drive chain affixed to a gear box.

4. An apparatus for releasing a single road cone at a timed interval comprising:
a mechanism comprising at least one reciprocating shoe which supports a plurality of road cones in a first position, and which lock a single cone on a second position which is then released at a timed interval;
a chute proximate to at least one reciprocating shoe to permit said released cone to slide downward toward the road surface; and
a vertical angle slide plate affixed to said chute to permit said cone to be released smoothly onto a road surface as the vehicle moves forward.

5. An apparatus for releasing a single road cone at a timed interval comprising:
(a) a mechanism comprising a pair of vertically separated reciprocating shoes for supporting a stack of road cones having a first pair of reciprocating shoes and which drop the stack of road cones onto a second pair of reciprocating shoes, said first pair closing to support the stack of cones above the lowermost cone and said second shoe pair then opening to release said single road cone;
(b) a chute proximate to the mechanism to permit said single cone to slide downward toward the road; and
(c) a spring angle slide plate to permit said cone to be released smoothly onto a road surface as the vehicle moves forward.

6. The apparatus of claim 5 wherein the mechanism operates under the control of a microprocessor pre-programmed with the speed of the vehicle.
